(19) United States
(12) Patent Application Publication
(10) Pub. No.: US 2025/0200523 A1
(43) Pub. Date: Jun. 19, 2025

(54) Dynamic Appointment Scheduling

(71) Applicant: Ocean Friends Inc., Irving, TX (US)

(72) Inventors: Animesh Kuumar, Irving, TX (US); Manish Shukla, North Bend, WA (US); Kushagra Mittal, Delhi (IN)

(73) Assignee: Ocean Friends Inc., Irving, TX (US)

(21) Appl. No.: 18/986,687

(22) Filed: Dec. 18, 2024

Related U.S. Application Data
(60) Provisional application No. 63/611,769, filed on Dec. 18, 2023.

(51) Int. Cl. G06Q 10/1093; G06F 3/04842

(52) U.S. Cl. CPC G06Q 10/1095; G06F 3/04842

(57) ABSTRACT

A system and a method for dynamic appointment scheduling receives a request from a user to book an appointment schedule, where the request also include one or more user preferences. One or more available appointment schedules are identified corresponding to the user preferences such that each appointment schedule includes one or more session slots. The available appointment schedules are presented to the user via a user interface. The user is allowed to select a preferred appointment schedule. Also, a waiting list option is presented such that the user optionally selects the waiting list option when at least one preferred session slot is unavailable. The user selection is then submitted and the selected appointment schedule is booked.

### CROSS-REFERENCE TO RELATED APPLICATIONS

This application claims the benefit under 35 U.S.C. § 119 (e) and 37 C.F.R. § 1.78 of U.S. Provisional Application No. 63/611,769, filed Dec. 18, 2023, which is incorporated by reference in its entirety.

### TECHNICAL FIELD

The present disclosure relates to a system and method for dynamic appointment scheduling. In particular, the disclosure relates to dynamically scheduling one or more appointments based on one or more user preferences. The system and method further allow the user to opt for a waiting list option in case a presented schedule of the one or more appointments does not fit the user's preferences.

### BACKGROUND

In the field of healthcare, it is a common practice to schedule appointments well in advance. However, due to unavoidable circumstances, scheduled appointments are subject to cancellation or patients may fail to attend. If not efficiently managed, such occurrences can lead to the inefficient use of medical practitioners' time, resulting in schedules peppered with unutilized time slots.

To counteract the impact of cancellations and absence of patients, many healthcare facilities adopt the strategy of overbooking appointments. This approach, however, comes with its own set of challenges. In situations where an unexpectedly high number of patients actually attend their appointments, overbooking can lead to unacceptably long waiting times for patients and potentially impose overtime demands on doctors.

Balancing the equation between making appointment decisions and accounting for various costs is a crucial concern for service providers in this domain. These costs encompass factors such as the expense associated with patient dissatisfaction and loss of goodwill, the costs incurred due to patient waiting time, the idle time of doctors, and any additional expenses incurred through overtime work. Further, the insurance amount is not refunded to the patient if the corresponding session is cancelled and not rescheduled on time. Also, with respect to the cancellation policies of various medical centres, a huge amount is charged from the patient for the therapy, if they cancel it in some pre-defined time interval. This leads to a great loss to the patient, since they have to bear the hefty charges of the treatment and it is not even refunded by the insurance companies, since the appointment is cancelled.

In recent years, there has been a growing demand for personalized healthcare experiences. Patients seek flexibility in scheduling appointments, and healthcare providers aim to optimize their resources while accommodating patient preferences. Additionally, the advent of digital technologies and online platforms has opened up new avenues for improving the appointment scheduling process.

Scheduling patient appointments in healthcare facilities is a critical aspect of ensuring timely and effective medical care. Traditional appointment scheduling systems often rely on fixed time slots, which may not align with the preferences or constraints of patients. Furthermore, the existing systems may not provide mechanisms for handling appointment cancellations or rescheduling in real-time, leading to inefficiencies and potential delays in patient care.

In light of the above discussed challenges and unmet needs, there is a need for an improved appointment scheduling system that can allow its users to book appointments remotely and can adjust in real time to accommodate any unforeseen situation. The present disclosure revolutionizes the conventional approach of appointment scheduling by introducing a dynamic, user-driven appointment scheduling system that maximizes flexibility, minimizes wait times, and enhances overall user satisfaction.

### SUMMARY

The present disclosure relates to a system and method for dynamic appointment scheduling. In particular, the disclosure relates to dynamically scheduling one or more sessions with an expert based on user preferences. The user can opt to join a waiting list in case the presented session slots do not fit his preferences.

In one aspect of the present invention, a method for dynamic appointment scheduling is disclosed. The method disclosed herein includes receiving a request from a user to book an appointment schedule based on one or more user preferences. The one or more available appointment schedules are then identified corresponding to the one or more user preferences. The appointment schedule disclosed herein includes one or more session slots. Further, the identified one or more available appointment schedules are presented to the user via a user interface. The user is further allowed to select a preferred appointment schedule from the presented appointment schedules. A waiting list option is also presented along with the appointment schedules. The user optionally selects the waiting list if at least one preferred session slot is unavailable. Finally, the user submits the selection to confirm booking of the selected appointment schedule.

In another aspect of the present invention, a computer implemented system for dynamic appointment scheduling is disclosed. The system includes a computing device including a user interface configured to allow access to an appointment scheduling platform. The system further includes a processing device operatively coupled to the appointment scheduling platform and is configured to store instructions to: receive a request from a user to book an appointment schedule based on one or more user preferences. One or more available appointment schedules are then identified corresponding to the one or more user preferences, where the appointment schedule includes one or more session slots. The one or more available appointment schedules are presented to the user via the user interface. The user is further allowed to select a preferred appointment schedule from the presented one or more appointment schedules. A waiting list option is also presented along with the appointment schedules. The user optionally selects the waiting list if at least one preferred session slot is unavailable. Finally, the user submits the selection to confirm booking of the selected appointment schedule.

In an aspect, the appointment scheduling platform allows the user to book one or more session slots while also selecting the waiting list option for another session slot that does not match user preferences. In this aspect, the user receives a notification on his mobile device or via the appointment scheduling platform when a preferred session slot is available to book against the waiting list.

In yet another aspect, the user may book one or more appointment schedules at a time for one or more patients based on one or more preferences.

Further, the appointment scheduling platform is configured to dynamically update the waiting list based on cancellation or rescheduling done by the user in the booked appointment schedule.

Advantageously, the appointment scheduling platform provides multilingual support, allowing the users to make the selections in their preferred language.

### BRIEF DESCRIPTION OF THE ACCOMPANYING DRAWING

The above-mentioned implementations are further described herein with reference to the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 illustrates a computer implemented dynamic appointment scheduling system.

FIG. 2 illustrates the example implementation of possible applications of the appointment scheduling platform.

FIG. 3 illustrates an exemplary implementation showing the details of the repository needed for generating one or more recommendations of one or more available appointment schedule and data insights.

FIG. 4 illustrates an exemplary view of the patient's schedule that is stored in the appointment scheduling platform.

FIG. 5 illustrates a method used for dynamic appointment scheduling.

FIG. 6 illustrates an exemplary method to schedule an appointment.

FIG. 7 illustrates an exemplary view of the front page of the appointment scheduling platform using which the user can book an appointment based on his/her preference.

FIG. 8a illustrates an exemplary view of the appointment scheduling platform where the user is allowed to select his/her preferences based on which appointment is scheduled.

FIG. 8b illustrates an exemplary view of the appointment scheduling platform where one or more automatically generated recommendations for one or more available appointment schedule are provided to the user based on his/her preferences.

FIG. 9 illustrates an exemplary view of the appointment scheduling platform where the user is provided with an option of registering to waiting list if the user is not satisfied with the recommended one or more appointment schedule or if preferred session slot is unavailable.

FIG. 10a illustrates an exemplary view of the notification shared to the user device, when a new session slot is available for booking.

FIG. 10b illustrates an exemplary view of the notification i.e., confirmation message shared to the user device, when the appointment scheduled by the user is confirmed.

### DETAILED DESCRIPTION

Embodiments, of the present disclosure, will now be described with reference to the accompanying drawing.

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the healthcare industry, the insurance pays only for completed appointment and it never pays for a cancelled appointment. There are lots of appointment cancellations and scheduling is a difficult task for these practices. A clinic may book a slot for you and sometimes you cancel at last minute due to unavoidable circumstances. There are lots of cancellation and the admin has to call people to know if they are coming for the appointment. The challenge here is that the admin needs to remember all the information related to cancellation due to which rescheduling becomes inefficient. Moreover, there are certain appointment slots that are prime and people are wanting those slots and they do not just get it because of the loss of data due to manual intervention. So, there is a lot of inefficiency in the system mainly when it comes to the utilization of the doctor's or the therapist's time and the services that the parents get.

Existing appointment scheduling systems require the users to mark an appointment on their calendar. Also, these systems do not have an option reschedule a session in real-time. Therefore, the user is required to call an admin present at the clinic to discuss and rescheduled the appointment. Especially, in cases where patients need to book a medical therapy session, this is a pressing requirement as therapists have back-to-back sessions and there are backlogs where parents have to wait a lot for their kids to get therapy. Certain therapy centers who did an internal study found that there is at least 20-25% leakage, where out of 1000 booked appointments in a month roughly 200 are getting cancelled. These are the cancelled slots that never get filled, while the centre has huge backlog where people want to schedule a session for their family members.

In contrast to the traditional appointment scheduling systems where patients are more or less told by the clinic when to come and whom to see or are given limited options on the phone, electronic appointment booking practices make it possible to better accommodate patient preferences by providing patients with more options. Giving patients more flexibility when scheduling their appointments has benefits that can go beyond simply having more satisfied patients. More satisfied patients lead to higher patient retention rates, which potentially allow providers to negotiate better reimbursement rates with payers. More satisfied patients can also lead to reduced absence rates, helping maintain the continuity of care and improve patient health outcomes. An important issue when providing flexibility to patients is that of managing the operational challenges posed by giving more options. In particular, one needs to carefully choose the level of flexibility offered to the patients while considering the operational consequences. It is not difficult to imagine that giving patients complete flexibility in choosing their appointment times would lead to high variability in the daily load of a clinic.

While the description presented herein makes a specific reference to therapy sessions of a child, it is to be appreciated that the present disclosure is also equally applicable to other health conditions or medical conditions for which the user has to schedule an appointment with an expert (a healthcare practitioner or expert). For example, the present disclosure may be useful in scheduling an appointment for:
Consultation and Follow Ups: this may include the normal scheduling made by the user for regular health checkup, doctor consultation, follow up and so on;
Medical Tests: this may include bookings made by the user at any hospital, clinic, centre for getting his/her tests done like blood test, EEG, ECG and so on;
Therapy Sessions: this may include all kind of therapies like medical therapies (speech, physical, occupational, behavioural, eye movement and so on), health-related therapies (diet, weight loss, music, psychiatric and so on);
Others: this may include all other activities for which the user needs to be schedule an appointment.

Further, the present disclosure is described with respect to a child as a patient who is undergoing therapy sessions and the user is child's parent who is accessing an appointment scheduling platform to schedule or reschedule sessions for the child. It should be noted that the patient can be any person (and not just a child) who needs assistance from an expert like doctor, therapist, physician, clinician and so on. Also, in the current example, the user is not only limited to parent of the child, it can also be caregiver, grandparents, family members, extended family members of the family who have access to the appointment scheduling platform. Also, the patient can also serve as a user, if he/she is capable enough to handle the appointment scheduling platform.

The present disclosure disclosed herein includes receiving a request from a user to book an appointment schedule, where the request includes one or more user preferences. The one or more available appointment schedules is then identified corresponding to the one or more user preferences. The appointment schedule disclosed herein includes one or more session slots. The one or more available appointment schedule is presented to the user via a user interface on the basis of one or more user preference, where a first appointment schedule is ranked higher in comparison to a second appointment schedule. The user is further allowed to select one or more preferred appointment schedule along with opting for a waiting list option. The user may select the waiting list if at least one preferred session slot is unavailable. Finally, notifying the user when the preferred session slot is available, where the selected appointment schedule is updated to include the preferred session slot based on user input.

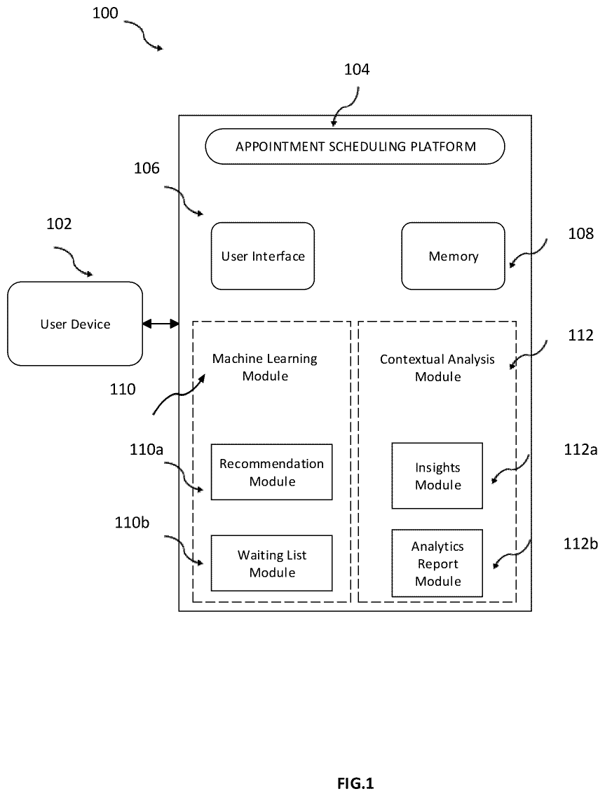

FIG. 1 illustrates a computer implemented dynamic appointment scheduling system 100 used for dynamic appointment scheduling, in accordance with one implementation of the present disclosure.

The dynamic appointment scheduling system 100 includes one or more components that work in tandem to provide a seamless user experience. As shown, the dynamic appointment scheduling system 100 includes a user device 102 that is operatively coupled to an appointment scheduling platform 104 using which a user can dynamically schedule one or more appointments. The appointment scheduling platform 104 further includes a user interface 106, a memory 108 configured to store instructions, user data, status of one or more session slots, appointment, cancellation details, and so on. The appointment scheduling platform 104 further includes a machine learning module 110 and a contextual analysis module 112. The machine learning module 110 further includes a recommendation module 110a configured to generate one or more recommendations related to appointment schedules and a waiting list module configured to suggest waiting list options to the user. In contrast, the contextual analysis module 112 includes an insights module 112a and an analytics report module 112b, where the insights modules 112 provide details related to appointments made by one or more users, cancellation trends, and so on, whereas the analytics report module 112b generate reports including one or more insights. Exemplary parameters and data source access included in a prompt provided to the machine learning module 110 to guide and constrain generation of recommendations include:
a) utilization of historical attendance data of the user. For instance, the dynamic appointment scheduling system 100 can analyze the user's past attendance patterns to derive insights about their likelihood of participation. For example, if a user has consistently maintained a high attendance record—say, 95%—the machine learning algorithm 110 may infer a strong probability of the user's attendance in future events or sessions. Such predictive prompt
s can serve to enhance the personalization and reliability of the recommendations generated by the machine learning module 110,
b) tracking and responding to progress trends. In other words, the machine learning algorithm considers the progress trajectory of the user within a specific time frame. For example, the machine learning module 110 may might identify a child demonstrating significant improvement in their performance or engagement levels during a given period. This information is used as a prompt to make decisions or recommendations tailored to encourage and sustain this progress, such as suggesting additional challenges or opportunities aligned with child's demonstrated growth, and
c) evaluating slot timing preferences. The machine learning module 110 also factors in the desirability of the time slot for the user. For instance, through analysis of user engagement patterns, the machine learning module 110 may might determine which time slots are most convenient or preferred by the user. Such an input allows the machine learning module 110 to prioritize scheduling or recommend sessions at times that maximize the likelihood of user participation, ensuring the dynamic appointment scheduling system 100 aligns with individual user preferences and constraints.

The user device 102 is any computing device that allows the user to interact with the appointment scheduling platform 104. Examples of the user device 102 include mobile device, computer, tablet, laptop, computer, and all other similar devices which allows user to access the appointment scheduling platform 104. For example, the user may access the user device 102 to book appointments and receive notifications related to confirmation of appointment, availability of new sessions, and so on. Further, as discussed herein, the user can be any person who has the access to the appointment scheduling platform 104, for example, the user disclosed herein might be the patient or any other person in relation with the patient. In the present disclosure, a child is undergoing some therapy sessions, so the user here is either the parent, caregiver, grandparent, extended family of the child.

The dynamic appointment scheduling system 100 includes a memory 108 which stores all the instructions to carry out the whole process of dynamically scheduling an appointment as per one or more preferences provided by the user using a user interface 106. The memory 108 is operatively coupled to the appointment scheduling platform 104, serving as a repository to store a diverse range of critical information. This includes instructions governing the system's 100 operations, user-specific data, status updates regarding one or more session slots, and a repository of available appointment schedules. This memory 108 maintains and manages the various facets of the appointment scheduling process. For example, the machine learning module 110 uses information stored in the memory, such as historical attendance data of the user, slot timing preference, progress trajectory of the user, etc. for making recommendations related to appointment schedules.

The memory 108 is further configured to store user data, status of the appointment and cancellation of the session slots, details of the one or more appointment schedule and so on. The user data disclosed here may include bibliographic details of the patient like age, address, name etc., medical history of the patient, treatment history of patient, daily schedule of the patient and so on.

The appointment scheduling platform 104 further includes a user interface 106 which is operatively coupled with the user device 102 and allows user to access the appointment scheduling platform 104 and provide their inputs wherever required. The user interface 106 allows the user to access and schedule one or more appointments dynamically on the platform 104. For example, the user receives one or more recommendations related to available appointment schedule or waiting list option via the user interface 106. The user interface 106 facilitates user interaction with the appointment scheduling platform 104. The user interface serves as the bridge between the user and the dynamic appointment scheduling system 100, providing a user-friendly environment for navigating through the scheduling options. The user interface 106 is designed to be intuitive, visually accessible, and conducive to a seamless user experience. The user interface 106 is thoughtfully designed to be visually appealing and easy to navigate, ensuring that users can effortlessly input their preferences and make informed scheduling decisions. The user interface 106 is uniquely designed to enhance clarity and usability by categorizing and displaying available slots in two distinct groups: a) Free Slots (Recommendations)—These are time slots identified as open and available for booking based on the user's preferences and the system's recommendations, and b) Recently Cancelled Slots—These are slots that were previously booked but have recently been cancelled, making them available for rebooking. By visually separating the categories of available slots, the user interface 106 ensures users can easily distinguish between standard recommendations and newly opened opportunities.

Further, a feature of the user interface 106 prioritizes the slots that have been recently cancelled, which now shows up as recently opened slots. These slots are prominently displayed at the top of the user interface 106. This design choice is grounded in user behavior analysis, which indicates that users are more likely to engage with the top-listed slots rather than scrolling through a longer list of slot recommendations.

Displaying recently opened slots at the top serves multiple purposes. a) the recently opened slots are ranked on top and thus offer have enhanced visibility to the users. Therefore, the user immediately see and can act on these high-priority slots without navigating through the interface extensively, b) the recently opened slots also increase booking efficiency by highlighting recently cancelled slots, as the dynamic appointment scheduling system 100 encourages quick rebooking, reducing downtime and improving overall system utilization, c) streamlines user experience—this design minimizes decision fatigue for users, aligning with their natural tendency to focus on readily accessible options.

To that end, the user interface structure and prioritization mechanisms contribute to both a seamless user experience and improved operational efficiency by facilitating faster rebooking of cancelled slots.

The user interface 106 is equipped with a range of interactive elements that guide the user through the appointment scheduling process. This may include input fields for specifying preferences such as desired date and time, preferred healthcare provider, location, and specialized area of medical expertise. Additionally, the user interface 106 may provide notifications of the available one or more session slots, notification of cancelled and booked appointment schedule, visual representations of available appointment schedules, allowing users to view session slots and make selections based on their preferences and so on.

The user interface 106 is operatively coupled to the machine learning module 110 and contextual analysis module 112 of the appointment scheduling platform 104. The user interface 106 incorporates a ranking system that distinguishes between available appointment schedules using a machine learning module 110. This visual hierarchy ensures that the first appointment schedule, which aligns most closely with the one or more user's preferences, is prominently featured and given higher priority compared to subsequent schedules. Prominently featuring the visual hierarchy streamlines the user's decision-making process and presents the user with the most suitable options in a clear and intuitive manner. The one or more recommendations of the available appointment schedule generated 110a using machine learning module 110 is presented to the user via the user interface 106. Some of the parameters used by the machine learning module 110 for ranking the recommended appointment schedules may include the following:

a) User Preferences Collection: The module 110 gathers data on user preferences, which could include factors such as preferred times, days, duration, location, or other constraints relevant to scheduling.

b) Data Analysis: The machine learning module 110 processes the user preferences data, possibly using supervised or unsupervised learning algorithms. The module 110 may also be trained on past user behavior or explicitly defined rules that prioritize certain factors.

c) Ranking the Schedules: The machine learning module 110 ranks the available schedules based on how closely they match the user's preferences. The most suitable options, which closely align with the user's needs, are ranked higher. This ranking could be influenced by factors such as time sensitivity, past user decisions, or the urgency of the appointment.

d) Prioritization: The top-ranked schedule, which aligns most closely with the user's preferences, is highlighted and given higher priority, ensuring that the most relevant option appears first.

e) Continuous Learning: Over time, the machine learning module 110 may adjust its recommendations based on user feedback or evolving patterns, refining the ranking system and providing increasingly accurate suggestions

The recommendation module 110a besides generating one or more recommendations of the available appointment schedule is also useful in generating other recommendations like recommending user about the therapist, recommending user about the therapy that they should undergo if the child or patient is facing such symptoms, recommending user about the session slots at any particular time which the user used to choose earlier, recommending user about the selection order of the therapies and so on. For example, the speech therapy works more efficiently on children who attend speech therapy sessions after the physical and occupational therapy. Then, in this case, based on the analysis done by the machine learning module 110, the recommendation generating module 110a will present the recommendation to the user in the appointment scheduling platform 104. This is just an exemplary scenario the user may get multiple number of recommendations based on which user gets help in selecting the best schedule of session slots which fits his/her preference.

The user interface 106 also includes interactive elements that enable users to select one or more preferred appointment schedules and, if necessary, opt for the waiting list option 110b using a machine learning module 110. Users can make these selections with ease, ensuring that their preferences are accurately captured by the machine learning module 110. In an event where the user chooses to join the waiting list 110b, the user interface 106 provides a seamless mechanism for expressing continued interest in preferred session slots that may be currently unavailable. This waiting list 110b feature is designed to offer reassurance to users, assuring them that their preferences remain on record in the memory 108 of the appointment scheduling platform 104 and that they will be promptly notified if any of their desired one or more session slots of their preference become available.

The machine learning module 110 of the dynamic appointment scheduling platform 104 represents a pivotal technological advancement. This module 110 is designed to enhance the user experience by generating personalized one or more appointment schedule recommendations 110a based on one or more user preferences provided by the user via the user interface 106. Leveraging sophisticated algorithms and historical user data, the machine learning module 110 analyses various factors such as user preferences, historical appointment patterns, and healthcare provider availability, date, time, timing gaps between various sessions and so on. By discerning patterns and trends, the machine learning module 110 formulates one or more appointment schedules that align with the one or more user preferences. This dynamic appointment schedule generation feature significantly streamlines the scheduling process, presenting users with options that are more likely to meet their specific needs. As a result, users are presented with a curated list of scheduling options that enhances their overall experience and ensures that the scheduling process remains user-centric.

In addition to the machine learning module 110, the contextual analysis module 112 of the appointment scheduling platform 104 includes insights module 112a that generates insights related to the appointment scheduling activities like booking and cancellation and analytics report module 112b to generate analytics reports based on one or more user preferences. By analyzing a wide array of contextual data, including historical appointment data, user preferences, and waiting list activity, the contextual analysis module 112 extracts valuable insights. These insights can encompass a variety of metrics, such as popular appointment times, preferred healthcare providers, frequently requested specialties and so on. The contextual analysis module 112 helps in providing an internal rating to each user based on various factors like response rate of user, cancellation rate of user, absent rate of user and so on. Based on this internal rating of the user, the preference of sharing of notification is given to the user who opted for waiting list option. The contextual analysis module 112 also has the capability to identify trends in scheduling behavior, enabling healthcare providers to adapt their offerings to better align with patient demands and so on. Furthermore, the generated reports can be utilized for strategic decision-making and process optimization within healthcare facilities. The contextual analysis module 112 can be a supervised learning model including logistic regression for binary classification tasks such as whether a patient is likely to cancel, a random forest regressor to handle complex and non-linear relationship in scheduling data, or other suitable models. The contextual analysis module 112 analyzes historical data to interpret user behavior and predict the likelihood of a slot being filled. Key factors such as attendance history, slot timing preferences, location proximity, and therapist recommendations are evaluated to generate insights. The system identifies trends by reviewing past patterns, such as frequently booked time slots, seasonal variations, and user engagement levels. Data is categorized and ranked to prioritize users or slots, enabling tailored recommendations and optimized scheduling decisions. Insights are then used for better decision-making and system efficiency.

This contextual analysis module 112 empowers healthcare providers with valuable data-driven insights, ensuring that the scheduling process remains efficient, adaptable, and attuned to the ever-evolving needs of patients.

Together, the machine learning module 110 and contextual analysis module 112 represent a cutting-edge approach to appointment scheduling. The machine learning module 110 leverages advanced algorithms to provide users with tailored appointment recommendations, optimizing the scheduling process. Simultaneously, the contextual analysis module 112 harnesses data analytics to extract valuable insights, allowing healthcare providers to refine their scheduling practices and enhance patient experiences. This combined technological framework ensures that the scheduling process remains dynamic, user-centric, and attuned to the preferences and demands of patients and healthcare providers alike. For instance, recommendations are generated based on the probability of a slot being filled successfully. This probability is calculated using multiple factors: Whether the open slot aligns with the user's desired times, user's historical attendance ratio with the therapist, distance between the user's location and the therapy center recommended, time required for the user to travel to the appointment. By combining these factors, the dynamic appointment scheduling system 100 ensures that recommendations are relevant, practical, and aligned with the user's preferences and logistics.

The user interface 106 present within the appointment scheduling platform 104 is operatively coupled with user device 102 using which the user can access the appointment scheduling platform 104 and can provide multiple inputs wherever needed. At the core of the dynamic appointment scheduling system 100 is a processing device (not shown in the figure) which includes the appointment scheduling platform 104 and all other components. This processing device is responsible for executing a series of instructions stored in the memory 108. These instructions explain the step-by-step process of dynamic appointment scheduling. The processing device is configured with the capability to receive one or more appointment requests from users via the user interface 106, comprehensively considering one or more user preferences. Upon receiving the user's request, the processing device embarks on the task of identifying available one or more appointment schedules that align with the one or more user preferences, which employs the machine learning module 110. This involves a careful analysis of the available session slots within the appointment schedule using the machine learning module 110. These session slots represent discrete time intervals within which appointments can be accommodated, offering a modular and adaptable framework for scheduling. Subsequently, the processing device is instrumental in presenting the identified available appointment schedules to the user via the user interface 106. The presentation of the one or more recommendation of available appointment schedules is distinguished by a ranking system, where the first appointment schedule, deemed to be the closest match to the user's preferences, is accorded a higher priority compared to a second appointment schedule and other subsequent schedules. This prioritization mechanism serves to streamline the user's decision-making process, presenting them with the most suitable options in a clear and intuitive manner. Furthermore, the processing device empowers the user to make selections based on their preferences. A user can choose one or more preferred appointment schedules, and the user is also provided with the option to join a waiting list via the waiting list module 110b. This waiting list feature acts as a contingency plan, ensuring that the user's preferences remain on record even in cases where the user's first-choice session slots are temporarily unavailable. In the event that a preferred session slot becomes available, the system's processing device is responsible for promptly notifying the user. The selected appointment schedule is then updated to incorporate the preferred session slot based on the user's inputs. This real-time update ensures that the scheduling process remains agile and responsive to changes in availability.

The notification is sent to the user on the user device 102 which is an aspect of the dynamic appointment scheduling dynamic appointment scheduling system 100. The notifications serves as a communication bridge between the user and the dynamic appointment scheduling system 100, ensuring timely updates and availability regarding the availability of the new one or more session slots, booked and cancelled appointment schedules of the user and so on. The notification shared with the user on user device 102 proactively informs the user when the user's preferred session slot is available or when there are updates related to the appointment schedule that they have made.

For example, upon detecting an available session slot that matches a user preference, the dynamic appointment scheduling system 100 trigger and shares a notification with the user on his/her device 102. The notification may be sent via email, SMS, WhatsApp or in the form of push notification through any other mobile application (also referred to as, App).

Exemplary contextual analysis models 112 may include various Generative Artificial Intelligence approach which may include GPT-3 (Generative Pre-trained Transformer 3), BERT (Bidirectional Encoder Representations from Transformers), ROBERTa (Robustly Optimized BERT Approach), ALBERT (A Lite BERT), T5 (Text-to-Text Transfer Transformer), or any other suitable models known to those skilled in the art.

The computer-implemented dynamic appointment scheduling system 100 for dynamic appointment scheduling is a sophisticated ensemble of components working in concert. The memory 108 stores actionable information, the appointment scheduling platform 104 with user interface 106 enables user interaction, and the machine learning module 110 and contextual analysis module 112 executes a sequence of instructions. This comprehensive dynamic appointment scheduling system 100, with its user-centric approach and adaptability, forms a pivotal advancement in the domain of appointment scheduling.

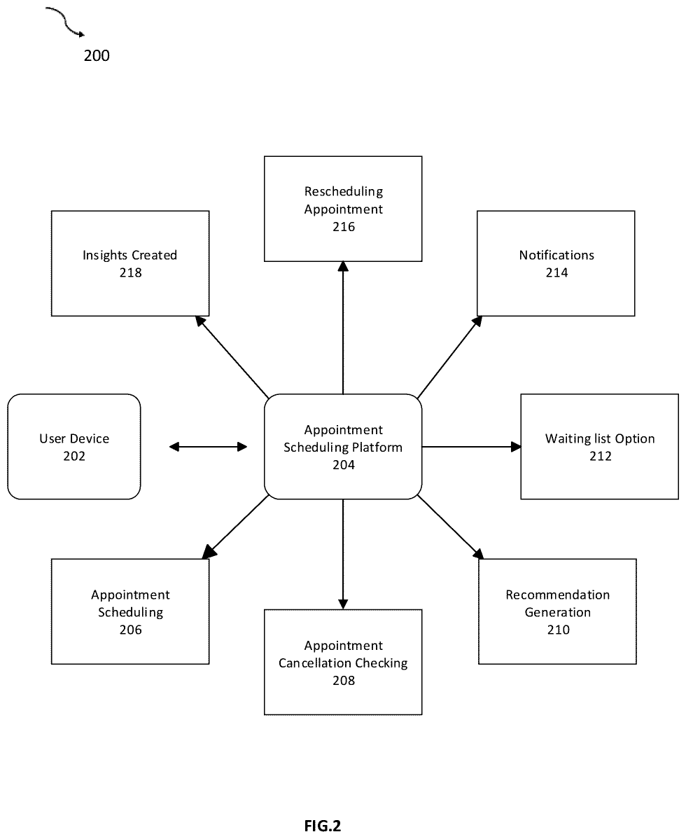

FIG. 2 illustrates a dynamic appointment scheduling system 200, which represents one embodiment of the dynamic appointment scheduling system of FIG. 1.

Referring to FIGS. 1 and 2, as discussed previously, the appointment scheduling platform 204 is accessed by the user via his user device 202. The appointment scheduling platform 204 is operatively and commutatively coupled with the user device 202, which allows the user to dynamically schedule one or more appointments for one or more patients. The appointment scheduling platform 204 offer various features as mentioned in detail below.

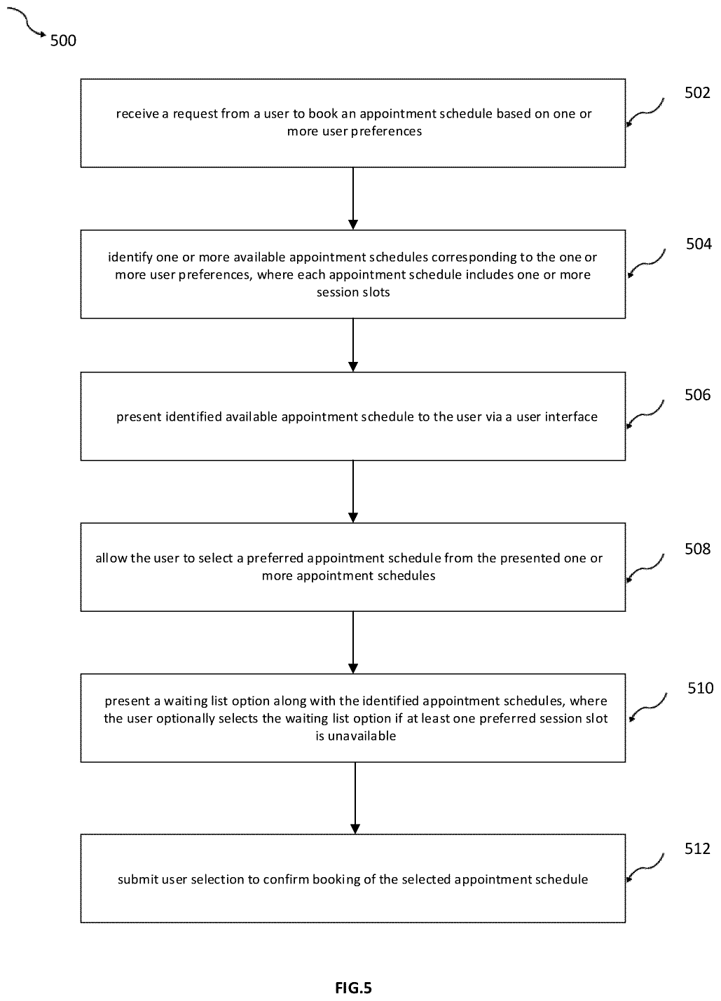

Appointment scheduling 206 is provided by the dynamic appointment scheduling 204. The user through the user device 102 initiates a scheduling process by submitting a request specifying the user's scheduling preferences, which may include parameters like preferred date, time, healthcare provider, location, specialized medical expertise required and so on. This information serves as the foundation for the subsequent steps in the scheduling process, which is illustratively described in FIG. 5. Leveraging a user-friendly user interface (not shown in the figure), each user can input the user's scheduling preferences with ease in multilingual format. Also, the user interface 106 allows the user with user device 102 to input the scheduling preferences in different formats like text, image, video, recording, and so on. The machine learning module 110 operatively coupled with the appointment scheduling platform 204 then evaluates these preferences against available appointment schedules, where each schedule may include one or more session slots. By aligning user preferences with the available slots, the appointment scheduling platform 204 provides a curated list of potential appointment schedule including one or more sessions slots, as requested.

In the event of appointment cancellations 208, appointment scheduling platform 204 is designed to promptly identify these changes. This is achieved through a real-time monitoring mechanism that constantly updates the availability of session slots. Upon receiving a cancellation request, the machine learning module 110 ensures that the now-available slot is promptly integrated into the list of potential appointment options presented to users. For example, when a cancellation occurs, the machine learning module 110 reviews all free slots available with therapists. From this list, the machine learning module 110 it identifies and ranks the slots based on priority, considering factors such as user preferences, historical attendance, and slot timing desirability. The cancelled slot, now reopened, is prominently displayed at the top of the recommendations list. This prioritization ensures the cancelled slot is filled quickly, optimizing scheduling efficiency and minimizing downtime for therapists. Other available slots are presented below the cancelled one, providing users with a clear, ranked selection of alternatives. Such a feature ensures that cancelled slots are swiftly re-allocated, optimizing utilization of healthcare providers time by minimizing unused appointment slots. Further, the memory 108 stores the details of the cancelled session slot in the memory 108 along with the user details, which helps in generating an internal rating of each user using a contextual analysis module operatively coupled to the processing device 204. This internal rating of each user is generated on the basis of various factors like rate of cancellation of booked appointment, rate of absenteeism, overall response rate, and so on. For example, if a user cancels his/her scheduled appointment very frequently, the user will be given a low rating and will be given a lower preference while sharing the notification of the newly available session slot. Although, this is one of the factors there are various factors for considering a user's profile while sending notification which will be discussed in detail below.

Further, recommendation generation 210 of available appointment schedules powered by machine learning module 110 of the appointment scheduling platform 204. This machine learning module 110 analyzes a multitude of variables, including one or more user preferences, historical appointment data, healthcare provider availability and so on. By discerning patterns and trends within this data, the appointment scheduling platform 204 formulates tailored suggestions for available appointment schedules. These recommendations are carefully ranked, with the first appointment schedule being accorded higher priority over second appointment schedule based on its alignment with the user's preferences. This dynamic recommendation streamlines the scheduling process, presenting users with options that are more likely to meet their specific needs.

The appointment scheduling platform 204 also offers users a valuable contingency plan in the form of a waiting list option 212. If a preferred session slot is currently unavailable, users have the choice to join the waiting list 212. This option ensures that users' preferences remain on record, signalling their interest in the desired slots. If any of these slots become available in the future due to cancellations or rescheduling, the appointment scheduling platform 204 promptly notifies users, providing an opportunity to secure the appointment. The user gets here multiple choices like if a user is not happy with the presented one or more appointment schedule, the user may directly opt for the waiting list option 212 and get notified whenever the preferred session slot is available. Further, the user may book an appointment schedule for one or more session and along with that can also opt for the waiting list option 212.

Further, the appointment scheduling platform 204 delivers notifications 214 to users to keep users informed about their appointments, cancellations, bookings, new session slots, and so on. For example, when a preferred session slot becomes available or if there are updates related to a scheduled appointment, the appointment scheduling platform 204 triggers notifications. These notifications can be dispatched through various channels, such as email, SMS, or push notifications through a mobile application. They contain pertinent details about the appointment, ensuring that users have the information they need to manage their healthcare schedule effectively. The notifications 214 are generated based on various criteria like first come first serve basis, revenue basis of therapy centre, emergency, internal ratings allotted to each user, and so on.

If a user chooses a new preferred session slot, the appointment scheduling platform 204 facilitates a seamless rescheduling process 216. The selected appointment schedule is promptly updated to incorporate the preferred session slot based on the user's input. Users indicate their preferences by filling out a waitlist, specifying the days and time slots that work best for them. The appointment scheduling dynamic appointment scheduling system 100 uses this information to match user preferences with available slots. More specifically, the machine learning module 110 evaluates the desirability of each available slot by cross-referencing it with the user's stated preferences. The machine leaning module 110 then prioritizes and recommends slots that align closely with the user's preferred days and times, ensuring personalized and efficient scheduling. This comparison allows the dynamic appointment scheduling system 100 to suggest the most suitable options, improving the likelihood of the slot being accepted and filled. Also, this ensures that the scheduling process remains agile and responsive to changes in availability. For example, if a user has booked an appointment schedule consisting of 3 therapy session, out of which he/she is comfortable with 2 sessions slot and booked the last one just for back-up and opted for waiting list option for this last session. Once the preferred session slot is available, the user gets notification 214 that the preferred session slot is vacant and he/she can make booking now. So, in this case, the user will cancel the previous booking of the last session slot and book his preferred session slot in place of that. The appointment scheduling platform 204 will reschedule the appointment 216 and provide the notification to the user about the same.

The appointment scheduling platform 204 incorporates a contextual analysis module 112 of FIG. 1, which works in tandem with the machine learning module 110 and the user interface 106. This contextual analysis module [INSERT contextual analysis module figure element number] is dedicated to extracting valuable insights and generating analytics reports and creating insights 218. By examining a rich array of contextual data, including historical appointment records, user preferences, and waiting list activity, the contextual analysis distills this information into actionable insights 218. These insights encompass a wide range of metrics, from popular appointment times to preferred healthcare providers and frequently requested specialties. Moreover, the contextual analysis module [INSERT contextual analysis module figure element number] identifies trends in scheduling behaviour, empowering healthcare providers with the knowledge needed to adapt their services to better align with patient demands. The generated reports serve as a reservoir of strategic intelligence, guiding decision-making processes and enabling the optimization of operational workflows within healthcare facilities. In essence, this module empowers healthcare providers with invaluable, data-driven insights, ensuring that the scheduling process remains both nimble and adept at meeting the ever-evolving needs of patients.

Overall, the dynamic appointment scheduling platform 204 combines these elements-user interface 106, machine learning module 110, and contextual analysis module [INSERT contextual analysis module figure element number]-into a sophisticated technological framework. This framework optimizes the scheduling process, providing users with a seamless and highly personalized experience while equipping healthcare providers with the intelligence needed to refine their scheduling practices. This holistic approach ensures that the scheduling process remains adaptable, user-centric, and finely tuned to the preferences and requirements of both patients and healthcare providers.

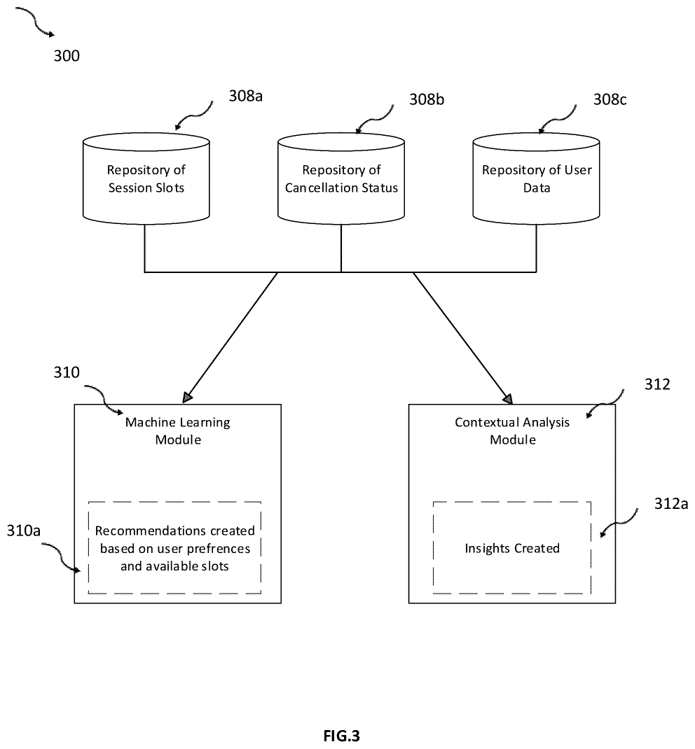

FIG. 3 illustrates an exemplary implementation 300 showing the details of the repository needed for generating one or more recommendations of one or more available appointment schedule and data insights, in accordance with one implementation of the present disclosure.

The shown implementation 300 discloses the use of machine learning module 310, contextual analysis module 312 using different type of input from the memory i.e., repository of one or more session slots 308a, repository of cancelled slots 308b, repository of user data 308c. As shown here, the machine learning module 310 generates one or more recommendations of available schedule 310a and further allows contextual analysis module 312 to generate insights and analytics report 312a based on the input data fed to them.

The data inputted by the user via the user interface 106 (FIG. 1) and data already stored in the memory is processed and analysed by the machine learning module 310 and the contextual analysis module 312 to generate one or more recommendations 310a of the one or more available schedule and insights and analytics report 312a.

The machine learning module 310 within the dynamic appointment scheduling system 300 operates by leveraging sophisticated algorithms and historical data stored in the appointment scheduling system 300's memory 308 (Need to add “308” to refer to “308a, b, & c” collectively) This memory serves as a repository containing crucial information, including a repository of available session slots 308a, a repository of cancelled slots 308b, and a repository of user data 308c. The machine learning module 310 allows the repositories 308a-308c to retrieve related data. The machine learning module 310 then conducts a comprehensive analysis, considering factors such as one or more user preferences, historical appointment patterns, the current availability of healthcare providers and so on. To accomplish this, the machine learning module 310 analyzes historical user data to interpret user behavior and predict the likelihood of a slot being filled. Key factors such as attendance history, slot timing preferences, location proximity, and therapist recommendations are evaluated to generate insights. The machine learning module 310 also identifies trends by reviewing past patterns, such as frequently booked time slots, seasonal variations, and user engagement levels. Real-time updates ensure that cancellations are quickly analyzed and slots are reallocated efficiently based on user preferences and availability. Data is categorized and ranked to prioritize users or slots, enabling tailored recommendations and optimized scheduling decisions. Insights are utilized better decision-making and system efficiency.

Through this process, the machine learning module 310 discerns underlying patterns and trends. Machine learning module 310 then utilizes these insights to generate tailored recommendations 310a for available appointment schedules. These recommendations 310a are meticulously crafted to closely align with the unique preferences of each user. This dynamic recommendation generation feature significantly streamlines the scheduling process, presenting users with a curated list of options that are highly likely to meet their specific needs. For example, looking after the schedule of the user from the repository of user data 308c which mainly includes details of user like name, age, address etc., medical history of user, treatment history of user, daily schedule of user and so on, the machine learning module 310 will not recommend any session slot to the user the time at which the user remains busy. For instance, the user child goes to school daily, except on weekends, between 10 AM-2 PM. Then, the machine learning module 310 will check the availability of session slots other than these timings and recommend them to the user, so that the child can easily maintain a synchronism between the school and the therapy.

In tandem with the machine learning module 310, the contextual analysis module 312 is a component of the system 300. The contextual analysis module 312 specializes in extracting actionable insights and generating comprehensive analytics reports 312a based on the extensive repository of data. Within the memory, it accesses a wealth of information including session slots 308a, cancelled slots 308b, and detailed user data 308c. To extract meaningful insights, the contextual analysis module 312 performs a rigorous analysis of this contextual data. This encompasses a thorough examination of historical appointment records, user-specific preferences, and waiting list activity. Through this process, the contextual analysis module 312 distills a wealth of valuable information. The contextual analysis module 312 encompasses a wide range of metrics, from determining peak appointment times to identifying preferred healthcare providers and frequently requested specialties. Beyond individual preferences, the contextual analysis module 312 has the capability to identify broader trends in scheduling behaviour. This valuable intelligence empowers healthcare providers with the knowledge needed to fine-tune their services to better align with the evolving demands of patients. Moreover, the reports generated by the contextual analysis module 312 serve as a reservoir of strategic intelligence. The reports guide decision-making processes and enable healthcare facilities to optimize their operational workflows. In essence, the contextual analysis module 312 empowers healthcare providers with invaluable, data-driven insights, ensuring that the scheduling process remains agile and adept at meeting the ever-evolving needs of patients.

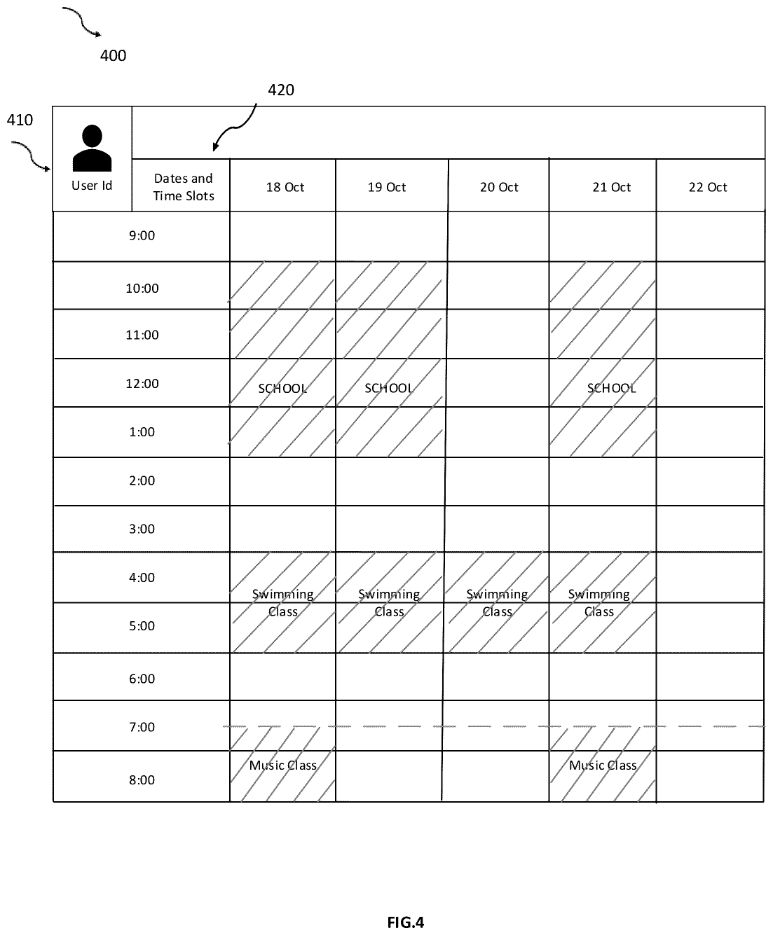

FIG. 4 illustrates an exemplary view of the patient's schedule 400 that is stored in the appointment scheduling platform 204 (FIG. 2), in accordance with one implementation of the present disclosure.

The exemplary view of the patient's schedule 400 is disclosed herein which is provided by the user, i.e., parent of a child in the present example. The user is not limited to a parent or a child. The user may be caregiver, family member, grandparents of the child, or any adult responsible for the child. Also, in this example, the child is considered as a patient, but the patient is not only limited to child, it may include any person and if the person is adult and has the knowledge to use appointment scheduling platform, the patient can be the user.

The patient's schedule 400 is stored in the memory (shown as 108 in FIG. 1) which is operatively coupled to the appointment scheduling platform 200. The user and the staff of the therapy centre (present example) both can access the patient's schedule 400 by clicking on the user ID tab 410 available on the appointment scheduling platform 200. This is just an exemplary scenario showing the patient's schedule 400, besides this the various other details of the patient are also made available on the appointment scheduling platform like medical history, treatment history, basic details like name, age, address, email and so on.

The patient's schedule 400 includes a tab ‘User Id’ 410 where the name and other details of the user are mentioned. Here in this example, the user is the mother of the child undergoing therapy. It further includes ‘Date’ 420 and ‘Time Slots’ which depicts the daily time schedule of the child. For example, it can be seen that the child remains busy from ‘10:00 AM-1:00 PM’ daily, except on ‘20th October 2023’ because of his school. Similarly, if we talk about a single day, say ‘18th October 2023’, the child remains busy between ‘10:00 AM-1:00 PM; 4:00 AM-5:00 PM; 7:00 AM-8:00 PM’ So, in this case, the contextual analysis module will analyse the intent behind the data provided by the user and based on that machine learning module will provide one or more recommendations of one or more available appointment schedules when the user is free.

Based on the inputs provided by the user, the machine learning module 310 and contextual analysis module will generate one or more recommendations of available appointment schedule. Recommendations are generated based on the probability of a slot being filled successfully. This probability is calculated using multiple factors including but not limited to—whether the open slot aligns with the user's preferences such as desired appointment slot time, user's historical attendance ratio with the therapist, distance between the user's location and the recommended therapy center, time required for the user to travel to the appointment. By combining these factors, the machine learning module 310 system ensures that recommendations are relevant, practical, and aligned with the user's preferences and logistics.

If the presented recommendations are as per user preferences, the user may book them or else has another option to opt the waiting list option, where the new available one or more session slots will be made available to the user based on his/her preferences.

FIG. 5 illustrates an exemplary dynamic appointment scheduling method 500 performed by at least one embodiment of the dynamic appointment scheduling system of FIG. 1. Referring to FIGS. 1 and 5, at 502, a user raises a request via the user device 102 for booking an appointment schedule with one or more therapists. To accomplish this, the user request is sent as an input data to the appointment scheduling platform 104 for booking the appointment schedule. The user request received from the user includes one or more user preferences which may include choice of day, date, timings, choice of expert like doctor, physician, therapist and so on, choice of the type of treatment like therapy session, regular follow ups, blood tests, consultations and so on. The user disclosed herein, for instance, in case of child being a patient and is undergoing therapy, may include parent, caregiver, grandparents, extended family members of the patient and so on. Further, if the patient is someone else, the user can be any person who has access to the appointment scheduling platform 104. The user may request to book one or more appointment schedules for one or more patients. For example, if the user has two children and both are undergoing therapies, then in this case, the parent of the child i.e., the user can book appointment schedule for both the children. It engages in the crucial task of identifying potential appointment schedules that align with the one or more preferences expressed by the user. These preferences tailor the scheduling process to suit the specific needs and constraints of the individual seeking the appointment. These preferences may encompass a range of factors, including the desired date and time of the appointment, the preferred healthcare provider, the location of the appointment, and the specialized area of medical expertise required.

At 504, one or more available appointment schedules are identified using the recommendation module (shown as 110a in FIG. 1), where the identified appointment schedules correspond to the one or more user preferences. The appointment schedules disclosed herein includes one or more session slots. By taking the one or more user preferences into account, the machine learning module 310 endeavours to create a scheduling solution that harmonizes with the user's unique circumstances. The machine learning module 310 generates recommendations based on probabilities calculated to rank available slots based on user preferences and historical data of the user among other parameters. For example, the module 310 uses user's historical data to identify scheduling patterns. For example, trends like higher attendance during specific times or days are factored into future scheduling recommendations. The machine learning module 310 also accesses user data to extract relevant user details, attendance histories, and therapist inputs. This information is then processed to make informed decisions regarding slot allocation and scheduling. Further, when allotting slots, the machine learning module 310 considers all gathered inputs to ensure optimal allocation. For instance, the module 310 ensures that the most suitable user receives the first opportunity to book the slot based on location, preferences, and attendance reliability. By considering user preferences, past behavior, and logistical constraints, the module 310 ensures recommendations are both relevant and actionable.

The appointment schedules, as defined in this disclosure, include a booking that encompasses one or more session slots. These session slots serve as discrete time intervals within which therapies can be accommodated. Each session slot represents a predefined block of time during which a patient can be scheduled for a medical appointment. This modular approach to scheduling allows for a high degree of flexibility, ensuring that appointments can be arranged in a manner that optimally utilizes the available time resources of healthcare providers. For instance, a session slot might correspond to a 30-minute period, during which a specific patient can be seen by a healthcare professional. This granularity in scheduling empowers the system to efficiently allocate appointments, accounting for both the user's preferences and the availability of healthcare providers.

At 506, presenting one or more available appointment schedules are presented to the user via user interface 106, which is operatively coupled with the appointment scheduling platform 104 (as shown in FIG. 1). The one or more available appointment schedule is presented on the basis of user preferences in which a first appointment schedule is ranked higher in comparison to a second appointment schedule. It progresses towards the interaction with the user by presenting the identified available appointment schedules. This presentation occurs through user interface 106 that is operatively coupled to the appointment scheduling platform 104. This user interface 106 serves as the medium through which the user of the user device 102 interacts with the appointment scheduling platform 104, providing a visual representation of the available appointment options. Through the user interface 106, the user gains access to a comprehensive view of the potential scheduling options tailored to their specific preferences, which were initially provided during the request for the appointment. This step prioritizes the presented appointment schedules based on the user's expressed preferences. Within the array of available schedules, the appointment scheduling platform 104 employs a ranking mechanism to distinguish between them. This ranking is a critical factor in the presentation process, as it ensures that the user is presented with options that are aligned more closely with their preferred parameters. Specifically, a first appointment schedule is accorded a higher priority or preference compared to a second appointment schedule. This prioritization is contingent on the degree to which the first schedule aligns with the user's initial preferences. It generates one or more recommendations of available one or more appointment schedule automatically based on one or more user data, appointment slots availability, cancellation status and so on, wherein the user data includes previous appointment history, medical history, user's schedule and so on.

At 508, the user is allowed to select a preferred appointment schedule via the user interface 106. Through the user interface 106, the individual is presented with the available appointment schedules that have been meticulously tailored to align with their specified preferences. At this juncture, the user is granted the ability to select one or more schedules that best suit their needs and constraints. This pivotal step is crucial in ensuring that the scheduling process remains highly adaptable and accommodating to the user's specific circumstances.

The method further includes an additional option of waiting list. At 510, the waiting list option is presented to the user, such that the user selects the waiting list option if at least one preferred session slot is unavailable. The waiting list is dynamically updated on a real-time basis using machine learning techniques based on cancellation of slots, rescheduling of slots, newly available slots, absence of patient and so on. This waiting list feature serves as a contingency plan, offering an alternative course of action in the event that the user's preferred session slots are currently unavailable. If the system detects that at least one of the preferred session slots is not presently open for scheduling, the user has the option to choose the waiting list. This strategic decision allows the user to express continued interest in the preferred slots, signalling their intent to be notified should any of these slots become available in the future.

At 512, the user submits his selection to confirm booking of selected appointment schedule, with or without option for the waiting list option. In case, the user selects the waiting list option, The notification regarding the preferred one or more session slot is shared with the user using an access link on his mobile device. The notification is sent to the user based on plurality of parameters like first come first served, emergency cases, internal rating allotted by the system to each user, revenue based and so on. The internal rating of the user is calculated based on various factors which may include response rate of the user, cancellation rate of the user, absence rate of the user and so on. The appointment schedule is then updated to include the preferred session slot based on user inputs.

The method 500 further allows user to directly sent a message using the user interface to the appointment scheduling platform that he/she wants to book an appointment at the particular time with the particular therapist, then the appointment will get booked automatically, if the slots are available at that particular time or else the user will get notified about the same, if the slots are not available.

The method 500 further allows providing the user's name automatically into the waiting list if the user cancels the appointment, whether it is done knowingly or unknowingly.

Thus, the method 500 allows for the incorporation of the user preferences, including date, time, healthcare provider, location, and specialty. This leads to a more personalized scheduling experience for patients by dynamically analysing available session slots in real time and ensuring the appointment is scheduled on the basis of current availability of the session slots, hereby reducing conflicts and delays.

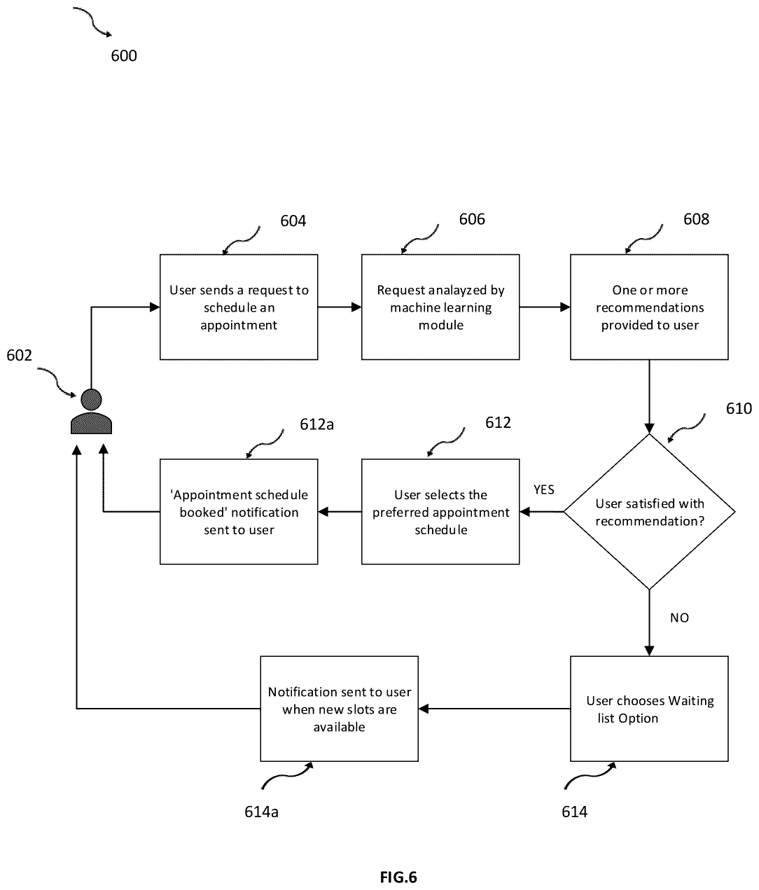

FIG. 6 illustrates an exemplary method to schedule an appointment, in accordance with one implementation of the present disclosure.

Considering the present exemplary scenario 600, where the user 602 is the mother of the child. Although not limited to, the user could be any other person as well, as explained above in detail.

The user 602 sends a request to schedule an appointment 604 to the therapy centre, where the therapy sessions of her child is taking place via. a user interface operatively of the appointment scheduling platform. The request 604 sent by the user 602 involves one or more preferences provided by the user like choice of therapist, choice of day, date, timing, choice of location and so on. The request 604 sent by the user 602 is then analysed and processed 606 using machine learning module to generate one or more recommendations 608 for the available appointment schedules. These recommendations 608 are generated based on the one or more preferences made by the user 602 while sending the request.

At 610, it is determined if the user 602 is satisfied with the one or more recommendations 608 of the available appointment schedules. User satisfaction with an allotted slot is inferred from their decision to book the slot. If the slot aligns with their current preferences, such as desired time, day, and convenience, the user is likely to proceed with booking. The dynamic appointment scheduling system 100 relies on this user behavior as an implicit indicator of satisfaction. High booking rates for recommended slots suggest that the recommendations effectively match user expectations and preferences.

To that end, if the user is satisfied, the user 602 books the preferred appointment schedule 612. As a result, a notification is sent 612a to user about the booked appointment schedule. In contrast, if the user 602 is not satisfied with the one or more recommendations 608 of the available schedules, then the user may opt for waiting list option 614. Thereafter, if the preferred session slot is available, a notification is sent to the user 614a. Let us discuss both the scenarios in detail.

In the first scenario, when the user 602 is satisfied with the one or more recommendations 608 of the available appointment schedule, then the user 602 books the particular appointments schedule in 612 and is notified in 614a on the user device 106 about the confirmed status of the scheduled appointment made by the user. Also, the appointment scheduling platform 104 is linked with a calendar application in the device of the user 602. The calendar application in the user device links the sessions slots in the appointments schedule with the calendar of the user 602 in order to remind him about the booking.

In the second scenario, the user 602 is not satisfied with the one or more recommendations 610 of the available appointment schedule, then the user has opted for the waiting list 614 option. The user 602 in this case will get notified 614a on her device when the preferred session slot is available which may be due to absence of any patient during that time, cancellation, rescheduling and so on. The notification 614a is sent to the user 602 based on various factors like first come first serve, revenue of therapy centre, emergency cases, internal rating given to each user and so on.

In an implementation, the user may click on “Book Appointment” button, which may be presented to the user via the user interface 106 of FIG. 1. Subsequently, the dynamic appointment scheduling system 100 first checks the user's calendar and the therapist's calendar to confirm the availability of the desired slot. This step ensures the appointment is still open for booking. If the slot is available, a request is generated to express the user's intent to book the appointment. Depending on the center's settings, this request can either be auto-approved or manually approved by the client. Once the request is approved, the dynamic appointment scheduling system 100 creates a document containing the appointment details. This document includes essential information such as the appointment's location, time, attendees, and client/user data. The appointment is then marked as active in the database, linking it to the user's calendar in the portal. When the client will open the portal, the dynamic appointment scheduling system 100 fetches all their appointments documents from database and arrange them in calendar by their date and time thus creating link between calendar and database.

This is just an exemplary scenario where the user 602 has directly scheduled an appointment schedule 612 or directly opted for waiting list 614. Although there could be other scenarios like user 602 can perform both operations at a time.

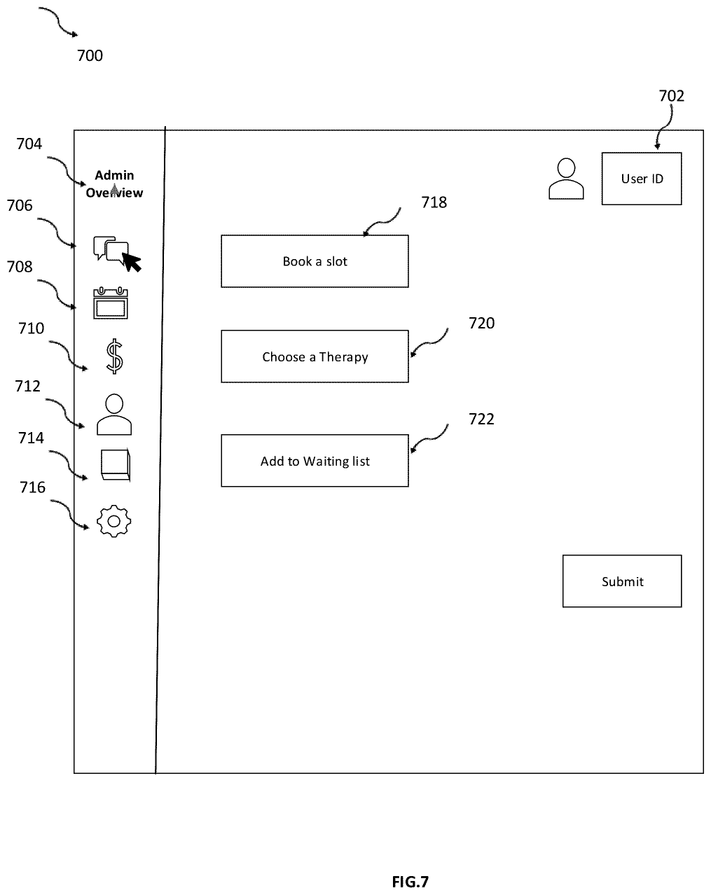

FIG. 7 illustrates an exemplary view of a front page of the appointment scheduling platform 700 using which the user can book an appointment based on his/her preferences, in accordance with one implementation of the present disclosure.

The exemplary front page 700 of the appointment scheduling platform is disclosed herein which can be accessed by the user who has the login credentials for this appointment scheduling platform. In this exemplary scenario, an example is considered where the user is parent of the child, who is undergoing some therapy. The patient can be anyone having direct access to the appointment scheduling platform. Further, the user can access the appointment scheduling platform using his/her device which may include mobile, tablet, laptop, computer, or any other similar device.

The front page 700 of the appointment scheduling platform includes user id 702 at the top right corner of the front page 700 of the appointment scheduling platform. Here the name of the user whosoever is accessing the platform is mentioned. The front page 700 of the appointment scheduling platform includes many options which can be selected by the user like ‘Admin Overview’ 704, ‘Scheduler’ 706, ‘Documents’ 708, ‘Billing’ 710, ‘User’ 712, ‘Insights’ 714, ‘Settings’ 716. The user can click on the corresponding option to visit that particular page and perform the corresponding action related to that similar page. For example, the ‘Admin Overview’ 704 allows user to get the overview of the appointment scheduling platform, ‘Scheduler’ 706 allows user to access the page from where the user can book one or more appointment schedules, ‘Billing’ 710 allows user to make bill payments of the scheduled appointment or any other payments that need to be made related to the appointment scheduling platform, ‘Documents’ 708 allows user to access the documents related to the appointment, session slots, user data and so on, ‘User’ 712 allows user to access the details of the patient which may include one or more than one like name, age, address, medical history, treatment history, schedule and so on, ‘Insights’ 714 allows user to access the analytics reports of the appointment slots availability and other details, ‘Settings’ 716 allows user to change the setting of the appointment scheduling platform such as preferred language and so on. The concerned person from the therapy centre, in case of present example, may also access the appointment scheduling platform but the use of these features mentioned above would be a little bit different from them. For example, like in case of ‘Insights’ 714, the therapy centre person will get the access to the analytics report based on topics like cancellation, available slots, internal rating of the user and so on.

Further, the appointment scheduling platform includes a tab named ‘Book a Slot’ 718 which depicts the heading of the front page 700 of the appointment scheduling platform. It further includes a tab ‘Choose a therapy’ 720 clicking on which the user gets multiple options of therapy like speech therapy, occupational therapy, physical therapy and so on.

It should be noted that these therapies are just an exemplary scenario in this case, however there are many other types of therapies, sessions, treatment and so on which a person undergoes and uses this appointment scheduling platform for the same. For example, the other situation may include diet related consultation, routine therapy of child or other person, scheduling for blood test, scheduling for report checkup and follow up, fitness related consultation, medical routine checkup and so on.

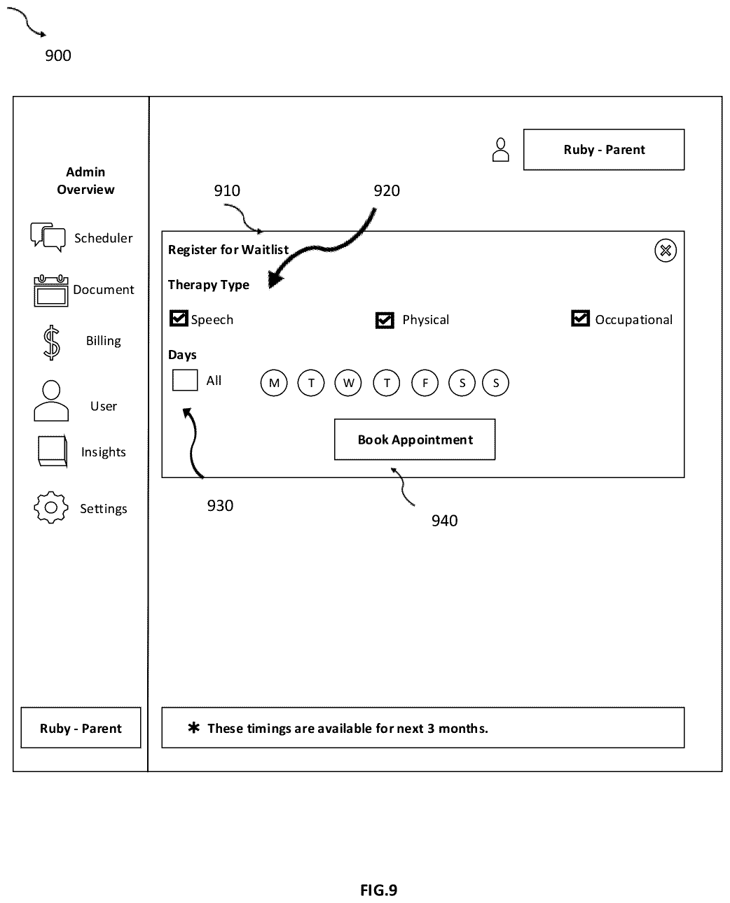

Further, the user gets a very interesting feature here in the disclosed appointment scheduling platform which states ‘Didn't find a slot, you can add yourself to waiting list’. It allows user to opt for a waiting list option 722 if they are not satisfied with the one or more recommendations of the one or more available appointment schedules provided to them by the appointment scheduling platform. This feature will be discussed in much detail in FIG. 9.

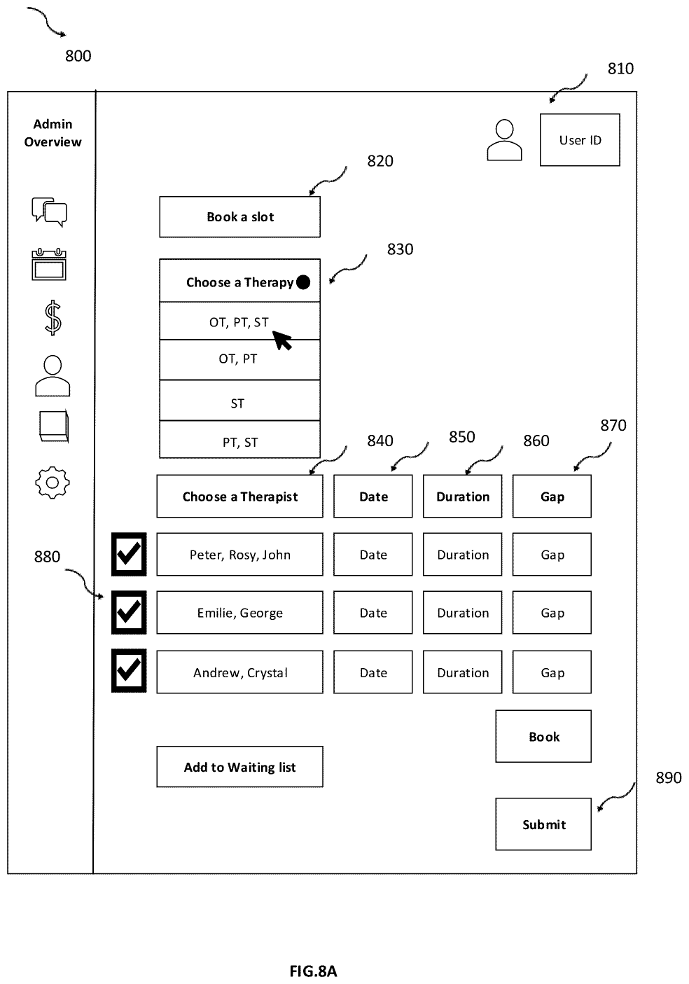

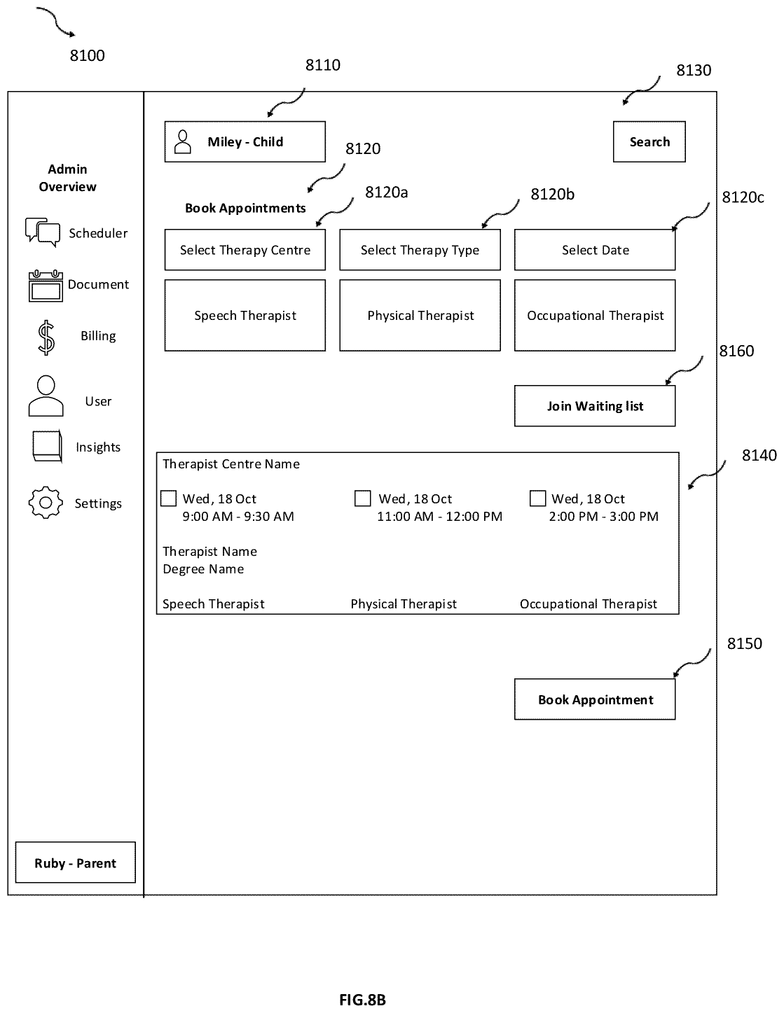

FIG. 8a illustrates an exemplary view of the appointment scheduling platform where the user is allowed to select his/her preferences based on which appointment is scheduled, in accordance with one implementation of the present disclosure.

The user preference filling page 800 of the appointment scheduling platform is disclosed in the given figure. The user preference filling page 800 allows user to enter their preferences based on which the one or more recommendations of one or more available appointment schedule are provided to them. It includes a tab ‘User id’ 810 which mentions the user's name of the person accessing the appointment scheduling platform. In this example, the user is the mother of the child i.e., Ruby, as discussed above it could be any other person as well.

The user preference filling page 800 includes a tab stating ‘Book a Slot’ 820 depicting the heading of the user preference filling page 800. It further includes a tab ‘Choose Therapy Type’ 830 which has a drop-down menu and allows user to select one or more therapy for which they wish to schedule an appointment. For example, it may include options like OT, PT, ST; OT, PT; ST; PT, ST and so on. Here OT, PT, ST stands for occupational therapy, physical therapy, and speech therapy respectively. This is just an exemplary scenario, although there could be any number of options depending upon the therapies, in case of present example, available in that therapy centre.

The user can further fill in their preferences like therapist, date of therapy, duration of therapy, gap between therapies by filling the details on various tabs like ‘Choose Therapist’ 840, ‘Date’ 850, ‘Duration’ 860 and ‘Gap’ 870. The user can either select one or more preferred therapist from the drop-down list present in the tab ‘Choose Therapist’ 840 or may directly select the tab ‘All’ 880 which will directly select all the therapist belonging to that particular therapy. Similarly, the user may select the date on which they want to schedule the therapy by clicking on tab ‘Date’ 850 and choosing the preferred date. The user may even choose different dates or same dates for one or more therapy sessions, as per there convenience. In a similar fashion, the user can select the duration of the therapy and the time gap between the two therapies by clicking on the tab ‘Duration’ 860 and ‘Gap’ 870 respectively. For example, the user has selected 3 therapy sessions for her child to be conducted on a day and the therapy sessions are of 1 hour each. The user marks a preference that she wants a gap of 1 hour between the first two therapies so that she can take her child for lunch during that time or may be any other reason. The one or more recommendations for one or more available appointment schedule will be presented to the user based on the above-mentioned preferences. The appointment scheduling platform will use machine learning module and generate one or more recommendations of one or more available appointment schedule for the user based on their one or more preferences.

Finally, after finally after filling all the preferences, the user may click on the tab ‘Submit’ 890 and submit his/her preferences and based on these preferences the machine learning module present in the system will one or more recommendations of one or more available appointment schedule which is discussed in detail in FIG. 8b.

The appointment scheduling platform also allows user to opt for a waiting list option by clicking the tab ‘Didn't find a lot you add yourself to the waiting list’ 890. The user selects the waiting list option 890 when the preferred session slot is unavailable and the user has no choices to make or else the user also has an option to choose both i.e., book an appointment schedule and go to waiting list option as well, if the booked schedule is not a proper fit as per user's preference. This will be discussed in detail in the latter section.

FIG. 8b illustrates an exemplary view of the appointment scheduling platform where one or more automatically generated recommendations for one or more available appointment schedules are provided to the user based on his/her preferences, in accordance with one implementation of the present disclosure.

The session slot booking page 8100 of the appointment scheduling platform is shown in the given figure. The session slot booking page 8100 allows user to book one or more appointment schedule and opt for a waiting list option, in case the preferred session slot is not available.

The session slots booking page 8100 includes a tab at the top of the page named ‘Child's Name’ 8110 i.e., ‘Miley’ in case of present example and a tab named ‘Book Appointments’ 8120 which depicts the heading of the session slot booking page 8100. The tab ‘Select therapy centre’ 8120a, ‘Select therapy type’ 8120b and ‘Select Date’ 8120c allows user to select the corresponding user preferences as shown in FIG. 8a, where the user has chosen different therapies i.e., OT, PT, ST which means that the user wants her child to undergo all the three therapies on the defined date and with a specific time gap. Based on these one or more user preferences, when the user clicks on the tab ‘Search’ 8130, the one or more recommendations of one or more available appointment schedule 8140 starts displaying on the session slot booking page 8100 of the appointment scheduling platform.

If the user finds any of the presented recommendations 8140 of available appointment schedule suitable as per his/her preferences, then the user may directly click on the tab ‘Book’ 8150 to schedule the corresponding session slot. On the contrary, if the user is not satisfied with the presented recommendations 8140, then he/she has an option to opt for waiting list by clicking on the tab ‘Join Waiting list’ 8160. The user may perform both the operations as well i.e., book a particular session slot with which he/she is not much satisfied and opt for waiting list option as well so that if in case in future the preferred session slot is available, the user can opt for it and cancel the one booked before.

FIG. 9 illustrates an exemplary view of the appointment scheduling platform where the user is provided with an option of registering to waiting list if the user is not satisfied with the recommended one or more appointment schedule or if preferred session slots are unavailable, in accordance with one implementation of the present disclosure.

The waiting list page 900 of the appointment scheduling platform is shown in the given figure. On clicking the tab ‘Join Waiting list’ the user get access to this page where the user may fill his/her preferences and join the waiting list.

There may be both the scenarios where the user joins the waiting list. Firstly, the user does not get preferred session slot and the user is not comfortable with the recommendations of available appointment schedule displayed on the appointment scheduling platform. In this case user directly joins the waiting list without making any prior booking, just waiting for the right session slot be available to him/her.

In second case also the scenario is same, the user does not get preferred session slot and the user is not comfortable with the recommendations of available appointment schedule displayed on the appointment scheduling platform, but to be on safer side the user books an appointment and chooses waiting list option as well either for one or more session slots. In this case, when the user gets the notification of the newly available preferred session slot, then he/she may book that if that is fulfilling his/her requirements and cancel the previously booked appointment or else continue with the previous one if the newly available session slot does not fit with his/her preferences.

The waiting list page 900 includes a tab at top stating ‘Register to Waiting list 910 which depicts the heading of the page and a tab ‘Therapy Type’ 920 using which the user can select the therapies for which the user wishes a preferred session slot. It may include all or any one of them, depends upon the situations. For example, if a user wishes to book for 3 therapies and while looking at the recommendations of available appointment schedule based on his/her preference founds that he/she is comfortable with the appointment schedule of 2 therapies but is not comfortable with 1 therapy session slot. In this case, the user may book the appointment for the 2 therapies and may either opt for waiting list directly for the remaining therapy or may book the session slot for that as well and opt for waiting list. Further, the user can select the ‘Days’ 930 on which he/she is available for the therapy and finally click on the tab ‘Book’ 940 to enter the waiting list. Once the user books into the waiting list, the system notifies user once a preferred session slot is available based on the user's preference.

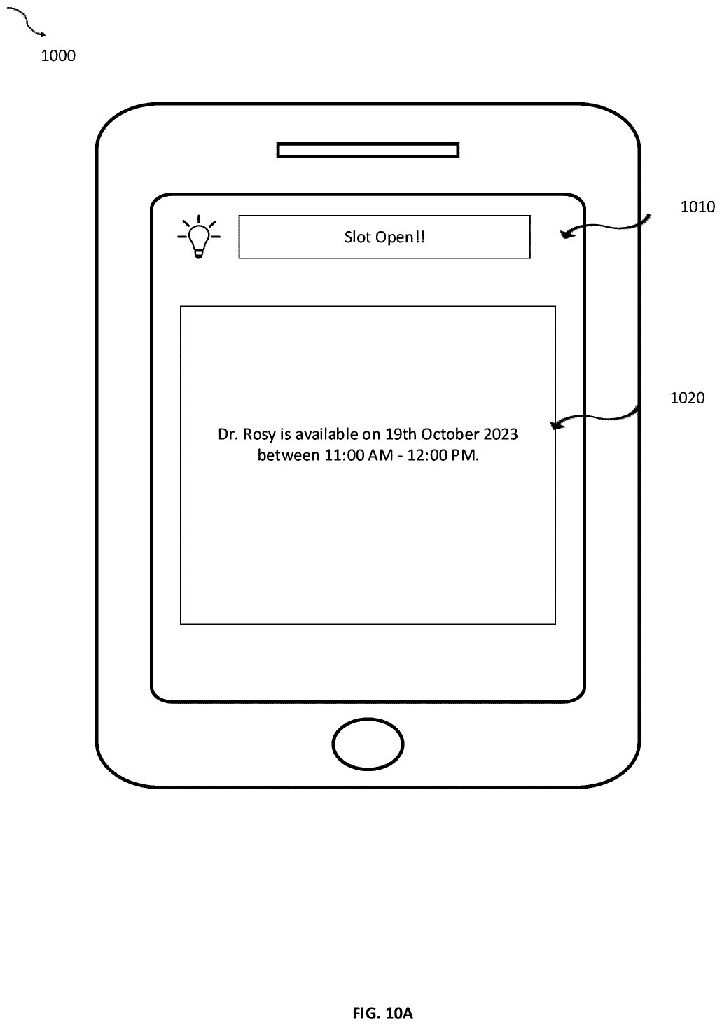

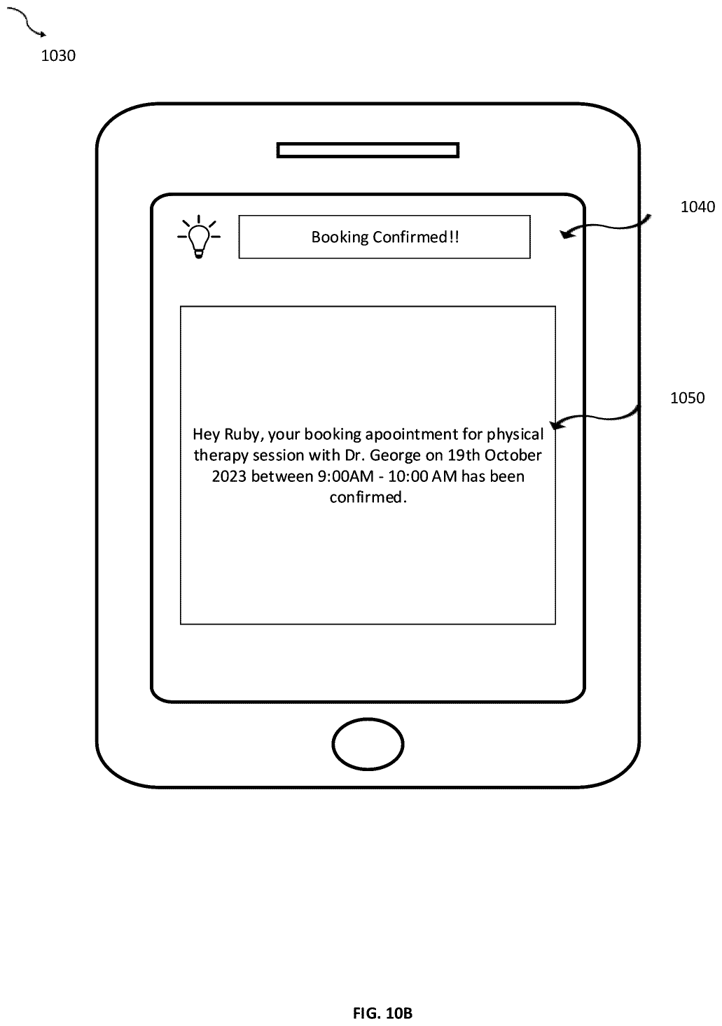

FIG. 10a illustrates an exemplary view of the notification shared to the user device, when the new session slots are available for booking, in accordance with one implementation of the present disclosure.

The exemplary view of the user device which is a mobile device 1000, in case of present example is disclosed herein. In this example, the user is scheduling an appointment for his/her child i.e., the user defined in this example is the parent of the child. Although as discussed previously, the user is not only limited to parent, but may also include caregivers, grandparents, other family members, extended family members or any other person who has access to the appointment scheduling platform. In present example, an appointment is scheduled for the child, who is the patient in this case and is undergoing some therapies in a therapy centre. But the patient is not limited to child and the treatment is not only limited to therapies and sessions. It may also include other persons as patient or any person seeking medical guidance or treatment like therapy, session, treatment, and so on.

The mobile device 1000 of the user disclosed herein is not only limited to a mobile device but may also include tablet, laptop, computer and so on. Similarly, the notification 1020 shared with the user on his/her mobile device 1000 may be obtained via. any medium like SMS, WhatsApp, Telegram, email, or any other similar platform and so on.

The user device i.e., a mobile device includes a notification heading named “Slot Open!!” 1010 and a message 1020 which states:

“Dr. Rosy is available on 19th October 2023 between 11:00 AM-12:00 PM.

Click on the link given below to book the appointment before somebody else does”.

This is just an exemplary scenario, a notification message 1020 for similar kind is shared with the user whosoever has opted for the waiting list option.

In this case, for example, the mother of the child waited to book one or more preferred session slots, who is undergoing some therapies at a therapy centre. The mother has some fixed preferences of therapist and timings at which the child is available to attend the therapy sessions. The machine learning module model has generated some recommendations of available appointment schedules for her child based on her preferences. But she was not comfortable with the timings or therapist of the recommended appointment schedule and as a result she selected waiting list option, which allows her to wait for the availability of the preferred session slot. There might be some situations like another patient is absent, someone has cancelled the appointment and so on, which results in availability of new session slots for scheduling appointment. Then in this case, the user who has opted for waiting list option will be notified along with a share link to book the appointment, if the newly available session slot fits their requirement.

Although this is just an exemplary scenario, where the user did not make any booking and directly choose waiting list option. There may be scenarios where the user is not satisfied with the recommendation of one or more available appointment schedule provided to him/her but still as they don't have any other option besides this and looking after the best option at the current moment, they may schedule an appointment that fits best in that situation and further opt for waiting list option as well, so that in case in future if any cancellation is there and one or more preferred session slots is available which fulfils his/her preference, then at that time the user may select the preferred session slot and cancel the old booking.

The system provides notifications to all those users who have opted for waiting list option. There are some criteria on the basis of which the users are selected from the waiting list which may include first come first serve basis, revenue based, emergency cases, internal ratings allotted to each user using contextual model.

The user gets notified from the message 1020 shared with them and the user can book the slots directly using the given link or by using the appointment scheduling platform.

FIG. 10b illustrates an exemplary view of the notification i.e., confirmation message shared to the user device, when the appointment scheduled by the user is confirmed, in accordance with one implementation of the present disclosure.

The exemplary view of the user device which is a mobile device 1030, in case of present example is disclosed herein. In this example, the user is scheduling an appointment for his/her child i.e., the user defined in this example is the parent of the child.

The mobile device 1030 of the user disclosed herein is not only limited to a mobile device but may also include tablet, laptop, computer and so on. Similarly, the notification 1050 shared with the user on his/her mobile device 1030 may be obtained via. any medium like SMS, WhatsApp, Telegram, email, or any other similar platform and so on.

The user device i.e., a mobile device includes a notification heading named “Booking Confirmed!!” 1040 and a message 1050 which states:

“Hey Ruby, your booking appointment for Physical therapy session with Dr. George on 19th October 2023 between 9:00 AM-10:00 AM has been confirmed”.

This is just an exemplary scenario, a notification message 1050 of similar kind is shared with the user once the booking is confirmed by the user. There may be scenarios where the user wishes to make multiple bookings on their preferred one or more session slots but they do not get the required session slots because they are unavailable, in that case they may either wait for the corresponding session slot availability or they are choosing some other appointment schedule which fits best at that situation.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims.

Exemplary Technical Advancements: The present disclosure described herein above to dynamically schedule an appointment has several technical advantages including, but not limited to, the realization of:
allows user to personalize appointment in real-time;
optimizes the allocation of appointment slots, ensuring that healthcare providers' time is utilized effectively and efficiently, leading to improved productivity;
provides a mechanism of waiting list for users to express interest in preferred slots that are currently unavailable;
provides flexibility to users while selecting preferences;
user friendly;
easy to use;
versatility of the user interface;
provides notifications to one or more users whenever there is any change in the status of the slots;
automatically generates recommendations based on user preference;
does not require manual intervention;
maintains transparency and security of the data.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A method for dynamic appointment scheduling, the method comprising:
receiving a request from a user to book an appointment schedule based on one or more user preferences;
identifying one or more available appointment schedules corresponding to the one or more user preferences, wherein each appointment schedule includes one or more session slots;
presenting the identified one or more appointment schedules to the user via a user interface;
allowing the user to select a preferred appointment schedule from the presented one or more appointment schedules;
presenting a waiting list option along with the identified appointment schedules, wherein the user optionally selects the waiting list option if at least one preferred session slot is unavailable; and
submitting user selection to confirm booking of the selected appointment schedule.

2. The method as claimed in claim 1, wherein the identified one or more appointment schedules further comprises a first appointment schedule and a second appointment schedule such that the first appointment schedule is ranked higher to the second appointment schedule based on the one or more user preferences.

3. The method as claimed in claim 1, wherein the user receives a notification on his mobile device when the at least one preferred slot is available, as selected in the waiting list option.

4. The method as claimed in claim 3, wherein the notification is shared in the form of an access link which is accessed by the user, via the user device interface, to confirm the booking that automatically adds the confirmed preferred slot to the appointment schedule of the user.

5. The method as claimed in claim 1, wherein the user preferences based on which the one or more appointment schedules are identified include date range, time window, choice of expert, session type, gap between appointment slots, or a combination thereof.

6. The method as claimed in claim 1 further comprises generating one or more recommendations of available one or more appointment schedules automatically based on at least one of the following-availability of slots, user's appointment history, user's calendar, medical situation, or a combination thereof.

7. The method as claimed in claim 1, wherein the waiting list dynamically updates based on cancellation of slots, rescheduling of slots, newly available slots, no show, or a combination thereof.

8. The method as claimed in claim 1, wherein one or more secondary users receive notification on their respective mobile device when the at least one session slot is cancelled by the user, wherein the notification includes an access link to book the cancelled session slot.

9. The method as claimed in claim 1 further includes booking of multiple session slots parallelly for multiple patients.

10. The method as claimed in claim 1, wherein the secondary users are the users who are in a waiting list to book a session slot of their choice such that the secondary users receive a notification if the chosen session slot is made available due to cancellation or rescheduling by the user who booked the slot in first place.

11. The method as claimed in claim 1, wherein a notification related to the session slot dynamically made available can be shared with the secondary users in batches such that a first set of secondary users are given priority to book the session slot over a second set of secondary users.

12. The method as claimed in claim 1, wherein the secondary users are allowed to book the available session slot based on one of the following-first come first serve basis, urgency to book the session slot, internal rating allotted to the secondary user, or a combination thereof.

13. The method as claimed in claim 12, wherein the internal rating allotted to the secondary users is calculated based on one or more of the following factors-response rate of the user, cancellation rate of the user, absence rate of the user, and so on.

14. The method as claimed in claim 1, wherein the scheduled session slots are automatically marked in user's calendar.

15. A computer implemented system for dynamic appointment scheduling, the system comprising:
a computing device comprising a user interface configured to allow access to an appointment scheduling platform;
a processing device operatively coupled to the appointment scheduling platform and is configured to store instructions to:
receive a request from a user to book an appointment schedule based on one or more user preferences;
identify one or more available appointment schedules corresponding to the one or more user preferences, wherein each appointment schedule includes one or more session slots;
present the identified one or more appointment schedules to the user via a user interface;
allow the user to select a preferred appointment schedule from the presented one or more appointment schedules;
present a waiting list option, wherein the user optionally selects the waiting list option if at least one preferred session slot is unavailable; and
submit user selection to confirm booking of the selected appointment schedule.

16. The system as claimed in claim 15, wherein the appointment scheduling platform further allows booking of one or more session slots while selecting the waiting list option for another session slot that does not match user preferences, wherein the user receives a notification on his mobile device or via the appointment scheduling platform when a preferred session slot is available to book against the waiting list.

17. The system as claimed in claim 15, wherein the appointment scheduling platform is further configured to dynamically update the waiting list based on cancellation or rescheduling done by the user in the booked appointment schedule.

18. The system as claimed in claim 15, wherein the system further comprises one or more of natural language processing, machine learning and generative AI models to analyze received user request and identify one or more available appointment schedules based on user preferences.

19. The system as claimed in claim 15 creates a unique user profile in the appointment scheduling platform which gets stored in the memory, wherein the memory further includes one or more user preferences, previous appointment data, previous cancellation data, user schedule, user medical data and other relevant user information for identifying one or more available appointment schedules that fits user preferences.

20. The system as claimed in claim 15, wherein the appointment scheduling platform provides multilingual support, allowing the users to make their selections in their preferred language.
